(19) United States
(12) Patent Application Publication
(10) Pub. No.: US 2013/0067366 A1
(43) Pub. Date: Mar. 14, 2013

(54) ESTABLISHING CONTENT NAVIGATION DIRECTION BASED ON DIRECTIONAL USER GESTURES

(71) Applicant: Gilead Almosnino, Redmond, WA (US)

(72) Inventor: Gilead Almosnino, Redmond, WA (US)

(73) Assignee: MICROSOFT CORPORATION, Redmond, WA (US)

(21) Appl. No.: 13/231,962

(22) Filed: Sep. 14, 2011

(51) Int. Cl. G06F 3/048

(52) U.S. Cl. 715/764

(57) ABSTRACT

Techniques involving the establishment of content navigational pattern direction based on directionally desired or intuitive gestures by users. One representative technique includes receiving user input that is indicative of a direction in which presented content that is arranged by sequence will be advanced. A navigation direction for the presented content is established such that it corresponds to the direction indicated by the user input.

### BACKGROUND

Computing devices capable of presenting content are teeming in society today. Mainframe terminals, desktop computing devices, laptop and other portable computers, smartphones and other hand-held devices, personal digital assistants, and other devices are often capable of presenting documents, images and a variety of content. The content may be locally stored, and in many cases is obtained from networks ranging from peer-to-peer networks to global networks such as the Internet. Like physical media such as books or magazines, the entirety of an electronic content item is often not presented all at once. Physical media is typically separated into pages or other discernible portions, as is electronic media. An electronic document may be segmented into presentable or otherwise consumable portions, whether segmented within the content itself or by the presenting device.

Since electronic content may be presented in portions, such as pages of a document, there may be times when the user will scroll through the document one or more pages at a time. A user may advance forward in a document by, for example, clicking a “next” or “forward” button mechanically or electronically provided on the device. Similarly, the user may go back in a document by clicking a “back” or analogous button provided on the user interface. These and other content navigation mechanisms can allow the user to navigate throughout the content item.

However, user interfaces for presenting electronic content can at times present ambiguous navigation choices. Navigation patterns often inherit layout directional orientation based on the user interface language. For instance, the user interface layout for English is left-to-right oriented. However, the operating system may be localized into other languages that are not left-to-right oriented, such as Arabic, Hebrew or any other bi-directional language. In such cases, the user interface layout may be adjusted to become right-to-left oriented.

Binding navigational control layout orientation to the user interface language directional orientation introduces limitations in the user experience. Such a “binding” can occur where content navigation patterns inherit the user interface orientation. In other words, if the user interface orientation is right-to-left (e.g. Arabic, Hebrew, etc.), then the content navigation direction inherits a right-to-left navigation. Thus, selecting a “next” user interface item would move ahead in the document by moving from right to left, which is different from how one would move ahead in the document if the user interface orientation would be left-to-right.

Under certain circumstances, the user interface orientation and the navigation control pattern layout direction may be opposite to that in which the document itself is oriented. For example, on an English user interface (e.g. using an operating system localized to the English language) with an English document, both the navigation pattern and document contents are oriented from left to right. Analogously, on a Hebrew user interface with a Hebrew document, both the navigation pattern and document content are oriented from right to left. However, on an English user interface, with a Hebrew document, the navigation pattern layout is opposite of the document layout. Similarly, on a Hebrew user interface with an English document, the navigation pattern layout is opposite of the document layout. These inconsistencies can cause ambiguity in using the user interface, as it may be unclear which direction will be taken in a document when a particular directional user interface item is selected. For example, where the user interface orientation differs from the presented document orientation, it may not be clear whether one would navigate forward by selecting a “next” or right arrow button. This ambiguity may result from, for example, uncertainty whether the navigation would follow the user interface orientation (e.g. right-to-left orientation) or the document orientation (e.g. left-to-right orientation). In these cases, the ambiguity can render the navigational user interface mechanisms of limited value, as the user may not be sure of the navigational direction that will be taken when such navigational mechanisms are used.

### SUMMARY

Techniques involving the establishment of content navigational pattern direction based on directionally desired or intuitive gestures by users. In one representative technique, a computer-implemented method includes receiving user input that is indicative of a direction in which presented content that is arranged by sequence will be advanced. A navigation direction for the presented content is established such that it corresponds to the direction indicated by the user input.

In another representative embodiment, an apparatus is provided that includes at least a touch-based user input, a processor, and a display. The touch-based user input may be configured to receive an initial user-initiated gesture that conveys a direction of a first attempt to navigationally advance a multi-part content item. The processor is configured to recognize the conveyed direction of the user-initiated gesture, determine a content navigation direction based on the conveyed direction, and establish the content navigation direction as the navigation direction of the multi-part content item. The current part of the multi-part content item may be presented via the display.

Another representative embodiment is directed to computer-readable media on which instructions are stored, for execution by a processor. When executed, the instructions perform functions including providing a user interface having an orientation corresponding to a language of an operating system executable by the processor. A multi-page document or other content may be presented with an orientation different from the orientation of the user interface. An initial touch gesture indicative of a direction for navigating forward in the multi-page content is identified, and a navigation direction for the multi-page content is established based on the direction indicated by the initial touch gesture. Navigating forward in the multi-page content can be accomplished by subsequent touch gestures in the same direction as the initial touch gesture, while navigating backwards in the multi-page content can be accomplished by subsequent touch gestures in a different direction relative to the initial touch gesture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram generally illustrating a representative manner for establishing content navigation direction based on user input gestures;

FIG. 2 is a diagram illustrating a representative manner of gesturing to identify an assumed or desired content pattern direction;

FIG. 3 is a flow diagram of a representative method for establishing content navigation direction based on a user's input gesture;

FIG. 4 is a flow diagram illustrating other representative embodiments relating to the establishment of a content navigation direction based on user input gestures;

FIGS. 5A-5D depict a representative manner of establishing content navigational direction, and subsequent navigation within the content once navigational direction is established;

FIG. 6 depicts a representative control states of pages or other content portions based on the type of orientation suggested by the user's input gesture;

FIGS. 7A, 7B and 7C illustrate a representative example of establishing a navigation pattern direction based on a user's touch gesture by way of a representative graphical user interface; and

FIG. 8 depicts a representative computing system in which the principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to user interfaces on computing devices capable of presenting content. Some content may be presented on computing devices a portion(s) at a time, such as documents, calendars, photo albums, etc. In many cases, the content is sufficiently large that it is not shown or otherwise presented all at once to the user. For example, a multi-page document may be presented one (or more) page at a time, where a user can selectively advance the content to read, view or otherwise consume the content. Similarly, calendars, photo albums, music playlists, electronic sketch pads and other content may explicitly or implicitly have an order or sequence associated therewith, whereby the content may be viewed in smaller portions at a time. Viewing such content may involve advancing through the sequence of content portions (e.g. pages, months in a calendar, etc.), and may also involve moving backwards in the sequence. The sequence may be based on logical arrangement such as successive pages of an electronic document, chronological arrangement of content such as calendars and photo albums, random arrangement, etc. In any event, it is not uncommon for users of computing devices of all types to consume viewable content in partitioned portions.

Users can move from one portion of the presented content to another, to view additional portions of the content. For example, a user may select a “forward” or “next” user interface (UI) mechanism to move to the next portion of the content in the sequence. Similarly, the user may select a “back” or analogous UI mechanism to return to the immediately preceding content portion. These and other UI mechanisms enable the user to navigate through documents and other content.

Navigation through portions of content may not always be intuitive. Device operating systems may support UI orientations, content orientations, and content navigational directions in multiple directions, thereby making the use of “next,” “back,” and/or other navigational UI mechanisms ambiguous or seemingly imprecise.

For example, operating systems may be available in many languages. Some languages inherently involves a left-to-right (LTR) orientation, where content is read from LTR, the UI is presented LTR, navigation through portions of content proceeds LTR, etc. English is such a language, where navigating through electronic documents occurs in the same fashion as a user reading a physical book written in English, which is from left to right. Other languages, such as Hebrew and Arabic, are written in right-to-left (RTL) orientation, or in some cases in bi-directional (bi-di) form where RTL text is mixed with LTR text in the same paragraph or other segment. In these cases, navigating through electronic documents corresponds to that of a physical book written in such languages, such is RTL.

Due at least to the different navigation directions for different languages, navigating through electronic documents can be confusing where the documents being presented are typically associated with one or the other of a LTR or RTL/bi-di language. For example, an English operating system may be configured to facilitate LTR progression through a document or other content, so that viewing a Hebrew or Arabic document on an English operating system can be confusing because the “next” page might actually be the previous page in a Hebrew document. Computing systems can quickly and easily present documents/content from any language, which differs from physical books which are typically written in a single language where navigation is consistent throughout. This flexible characteristic of computing systems, and virtually inexhaustible availability of content via networks and other sources, creates these and other new challenges for device users.

To address these and other problems, the present disclosure provides solutions to dynamically establish content navigation patterns/directions from user input suggestive of a navigation direction intuitive to or otherwise attempted by the user consuming the content. Among other things, techniques described in the disclosure enable UI gestures of the user to be leveraged in order to establish the navigational pattern for at least the instance of content presented to the user. In one embodiment, a user's initial navigational gesture(s) relative to a content item can be recognized, and used to establish the navigational direction for at least the content currently being consumed by the user. This enables sections of a content item to be presented in an order that is determined to be intuitive for the user for that content, without expressly notifying the user how the navigational pattern is being established or that it is even being established the user. Such a system may also obviate the use of feedback for incorrect content navigation, since any supported navigation direction is dynamically configured for the user.

Thus, among other things, techniques described in the disclosure facilitate the receipt of user input indicative of a direction for advancing presented content arranged by sequence. A navigation direction is established for the presented content to correspond to the direction indicated by the user input. These and other embodiments are described in greater detail below.

Various embodiments below are described in terms of touchscreens and other touch-based UI devices. A user “swiping” or otherwise moving a finger(s) on a touchscreen or touchpad can provide an indication of which direction the user intuitively wants to advance (or move back) in a document or other content item. However, the principles described herein are applicable to other UI mechanisms capable of indicating direction, such as joysticks, UI wheels/balls, keyboard arrows, etc. Therefore, reference to any particular directional UI mechanism is not intended to limit the disclosure to such referenced UI mechanism, unless otherwise noted. Further, while certain languages are used herein for purposes of illustration (e.g. English, Hebrew, Arabic, etc.), these are referenced for purposes of example only. The principles described herein are applicable to any content item that may be advanced in more than one direction based on various factors (LTR or RTL languages represent an example of such factors).

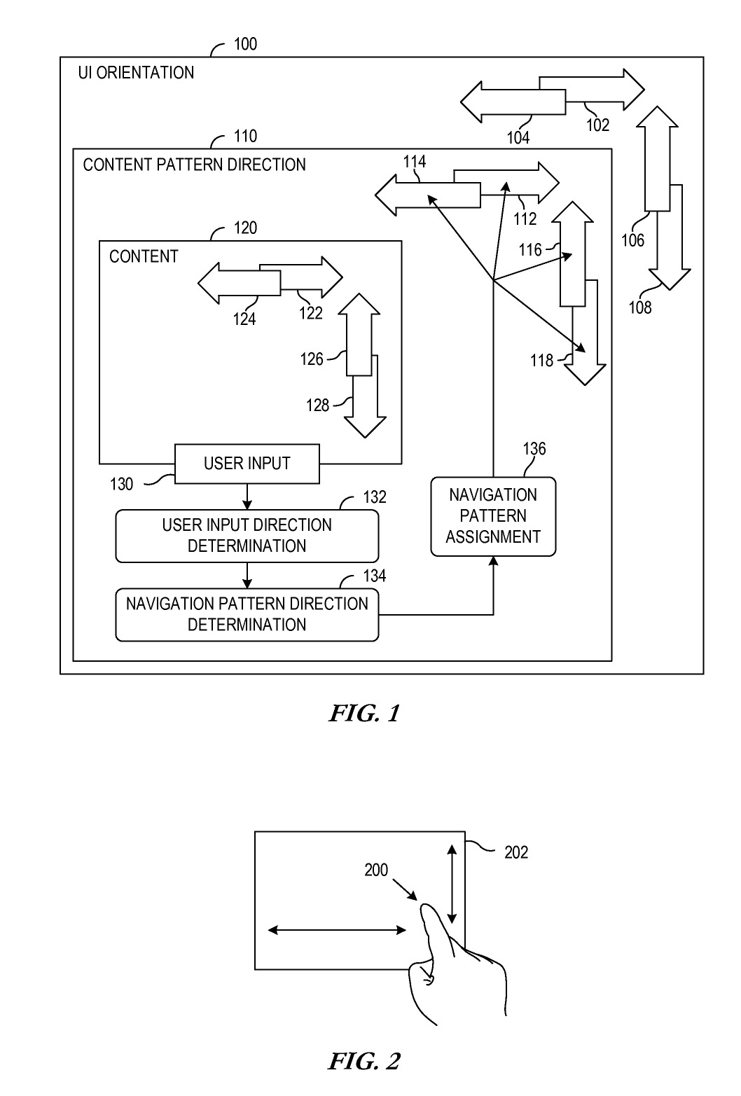

FIG. 1 is a diagram generally illustrating a representative manner for establishing content navigation direction based on user input gestures. In this example, a UI orientation 100 represents a layout of electronic user interface items provided by, for example, an operating system or other application operable on the hosting device. Assuming for purposes of discussion that the UI orientation 100 is configured by the operating system, the language of that operating system may affect the layout of the presented UI. For example, an English version of an operating system may present the UI in a left-to-right (LTR) manner, as depicted by arrow 102. A Hebrew or Arabic version of the operating system may present the UI in a right-to-left (RTL) manner, as depicted by arrow 104. In other embodiments involving languages or otherwise, still other orientations such as up 106 and down 108 may be presented. Thus, UI controls (e.g. start menus, minimize/maximize controls, etc.) may be presented in different orientations depending on the language of the operating system, or on other factors that may impact UI orientation 100.

In some cases, content pattern direction 110 inherits the UI orientation 100 provided by the operating system. Thus, if the UI orientation 100 is LTR (e.g. English operating system), the content pattern direction 110 will default to advance content from LTR since English documents typically advance from left to right. As noted above, however, the ability of a computing system running a particular operating system to enable consumption of LTR, RTL and bi-directional languages may make an inherited content pattern direction 110 unsuitable, or at least non-intuitive, for some content 120.

More particularly, the content 120 may be oriented in various directions. An English language document may be written from left-to-right, as noted by LTR arrow 122. A Hebrew or Arabic document may be written from right-to-left, as noted by arrow 124. Other languages may be oriented from top-to-bottom 128 or otherwise. For reasons of language or other factors, the direction of content 120 may be in any direction, including those shown by LTR arrow 122, RTL arrow 124, bottom-to-top arrow 126, top-to-bottom arrow 128, or theoretically in a direction other than horizontal or vertical.

When reading a document or consuming other content 120 oriented in a particular direction as depicted by arrows 122, 124, 126 or 128, a particular content pattern direction 110 may typically be associated with that content 120 orientation. For example, for an English document written left-to-right as shown by LTR arrow 122, the content pattern direction 110 advancement may also be from left-to-right (e.g. document pages may be turned from left to right). However, if the content 120 is a Hebrew document, and the content pattern direction 110 inherited the UI orientation 100 of an English operating system, a LTR navigation direction noted by LTR arrow 122 would be counter-intuitive for the right-to-left Hebrew content 120 depicted by the RTL arrow 124. The present disclosure provides solutions to these and other inconsistencies associated with directional user interfaces and directional navigation of content.

The user input 130 represents a mechanism(s) facilitating at least a directional gesture(s) by the device user. The user input 130 may include any one or more of, for example, a touchscreen, touchpad, joystick, directional keys, visually-presented UI buttons, UI wheels or balls, etc. In one embodiment, the user input 130 represents a touchscreen or touchpad, where the user can make touch gestures that indicate direction such as swiping a finger in a particular direction.

For example, if the UI orientation 100 is RTL (e.g. configured with a Hebrew operating system), a content 120 item written LTR may be presented. If the content 120 is presented in English, for example, the user may want to advance the content 120 portions in a LTR content pattern direction 110. To do this, the user can use the user input 130 to indicate that the content 120 will be advanced from left-to-right as depicted by LTR arrow 122, even though (or regardless of whether) the UI orientation 100 is configured RTL. The user may, for example, drag a finger from right to left, simulating a page turn in content 120 arranged left-to-right.

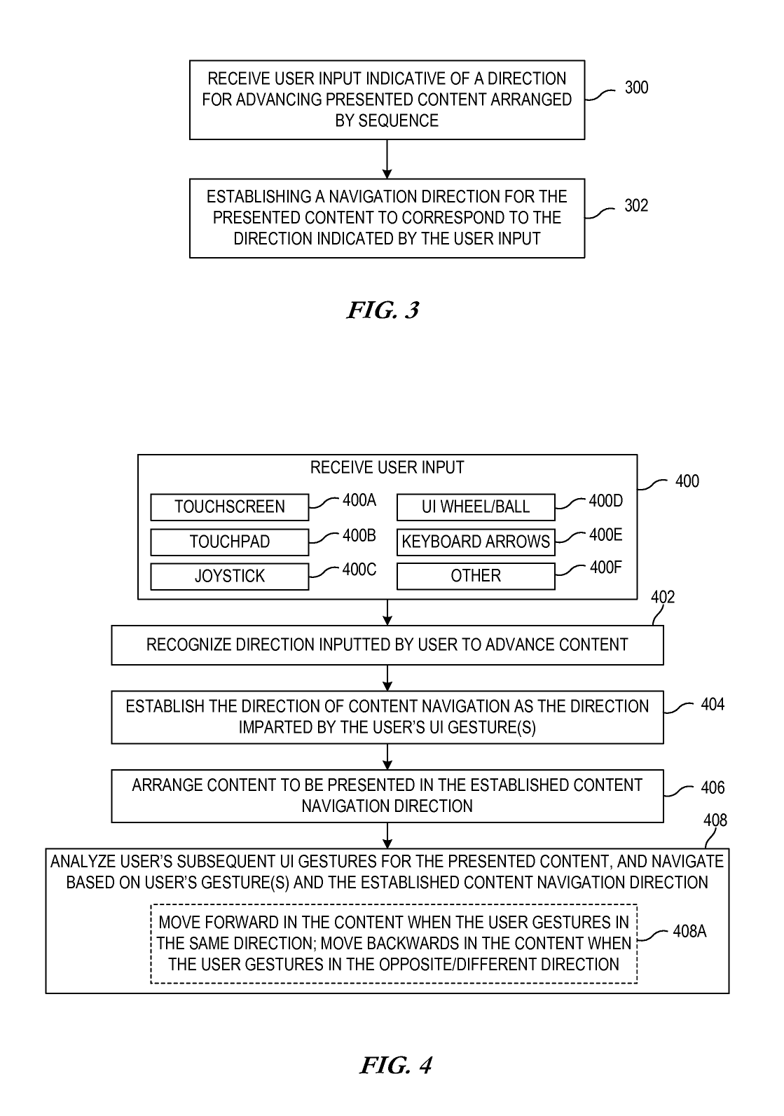

This is depicted in FIG. 2, which is a diagram illustrating a representative manner of gesturing to identify an assumed or desired content pattern direction. FIG. 2 assumes a touchscreen or touchpad as the user input. Where the user moves his/her finger 200 from the right side of the screen 202 to the left side of the screen 202, this mimics or otherwise simulates a page turn in a LTR-oriented document. This initial “gesture” suggests a LTR orientation of the content being consumed, which establishes the content pattern direction for the presentation of other pages or portions of that content. As shown in FIG. 2, the user can gesture in any direction to indicate a content pattern direction.

Returning now to FIG. 1, the gesture(s) is made by way of the user input, and the direction gestured by the user is determined as depicted at block 132. In one embodiment, the user input direction determination block 132 represents a module capable of determining the direction gestured by the user, such as a module implemented by software executable via a processor(s) to calculate touch points recognized by the user input 130. For example, the user input 130 may suggest relatively stable Y coordinates, with decreasing X coordinates on an X-Y coordinate plane, thereby suggesting a touch direction from right to left. Using this information, the navigation pattern direction may be determined as depicted at block 134. This may also be implemented by software executable via a processor(s), but may be configured to determine the content pattern direction 110 in view of the directional information determined at block 132. For example, if the user input direction is determined at block 132 to be from right to left, the navigation pattern direction determination at block 134 may determine that such a gesture corresponds to a LTR content pattern direction 110, as content advancing from left to right may involve a “page turn” using a finger from right to left.

When the navigation pattern direction is determined at block 134, that navigation pattern may be assigned to that instance of the content, as shown at block 136. For example, one embodiment involves making the determinations at blocks 132, 134 in connection with the user's first UI gesture for that content 120, and the navigation pattern for the remainder of that content 120 is consequently established or assigned as shown at block 136. In one example, a right-to-left “swipe” as determined at block 132 may result in a determination of a LTR content pattern direction 110 as determined at block 134. In such an example, a user's further right-to-left swipe will advance the content 120 forward in its sequence, such as moving to the next page or segment of the content 120. A user's swipe in the opposite direction, i.e. left-to-right swipe, would then cause the content 120 to move back to an immediately preceding page or segment. This “forward” and “back” direction is established based on the user's initial gesture that caused the navigation pattern assignment as shown at block 136. In this manner, the user can initially gesture in an intuitive, desired, or other manner, and the content pattern direction 110 is assigned accordingly as depicted by the various directional arrows 112, 114, 116, 118.

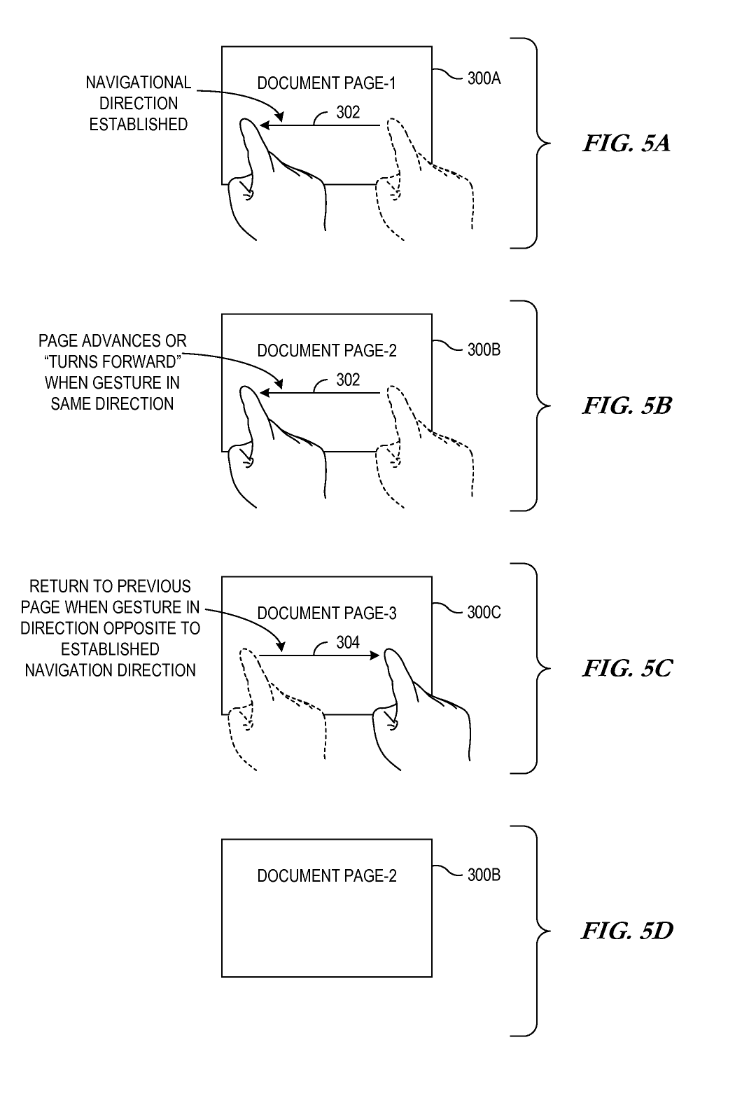

FIG. 3 is a flow diagram of a representative method for establishing content navigation direction based on a user's input gesture. In this example, user input is received as shown at block 300, where the received user input is indicative of a direction for advancing presented content arranged by sequence. A navigation direction for the presented content is established to correspond to the direction indicated by the user input as shown at block 302. In this manner, the user can set the navigational pattern to match the document direction, or alternatively set the navigational pattern in a desired direction regardless of the orientation of the document or other content.

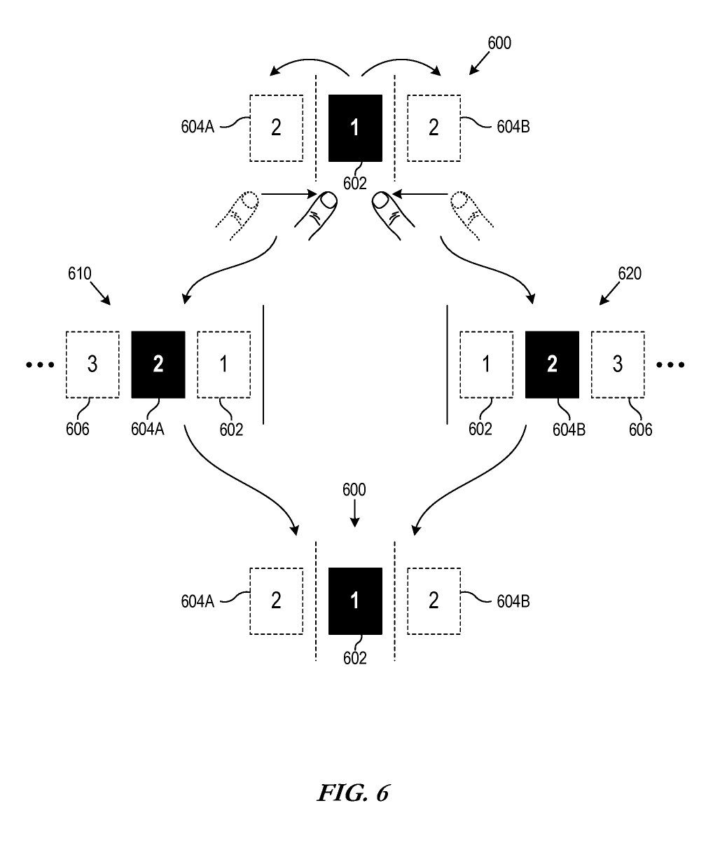

FIG. 4 is a flow diagram illustrating other representative embodiments relating to the establishment of a content navigation direction based on user input gestures. User input is received as depicted at block 400. Such user input may be in the form of, for example, a touchscreen 400A, touchpad 400B, joystick 400C, UI wheel/ball 400D, keyboard or graphical user interface (GUI) arrows 400E, and/or other input 400F. The direction inputted by the user to first advance the content is recognized as depicted at block 402. For example, if the user input at block 400 represents a touchscreen 400A or touchpad 400B, the direction inputted by the user to advance content may be recognized at block 402 by the user dragging his/her finger in a particular direction. In the illustrated embodiment, the direction of content navigation is established at block 404 as the direction imparted by the users UI gestures. In one embodiment, the direction is established at block 404 based on the user's first gesture made via the user input at block 400 for the particular content being consumed.

In one embodiment, the content to be presented in the established content navigation direction is arranged, as depicted at block 406. For example, once the content navigation direction is known, other portions (e.g. pages) of that content can be arranged such that a forward advancement will move to the next content portion, whereas a backward movement will move to a previous content portion.

As shown at block 408, the user's subsequent UI gestures for the presented content are analyzed. Navigation through that content is based on the user's gestures and the established content navigation direction. In one embodiment, consuming the content advances by way of user gestures made in the same direction that initially established the content navigation direction. For example, as shown at block 408A, the user may move forward in the content when the user gestures in the same direction used to establish the content navigation direction, and may move backwards in the content when the user gestures in the opposite or at least a different direction.

One embodiment therefore involves receiving user input at block 400 that indicates the direction for advancing the presented content as determined at block 402, where the presented content is then arranged at block 406 in response to establishing the direction of the content navigation at block 404. The presented content may be arranged to advance the presented content forward in response to further user input imparting the same direction. In another embodiment, the presented content is arranged to move backwards in the arranged sequence of the presented content in response to user input imparting a direction opposite to, or in some embodiments at least different than, the direction of the initial user input that established the navigation direction.

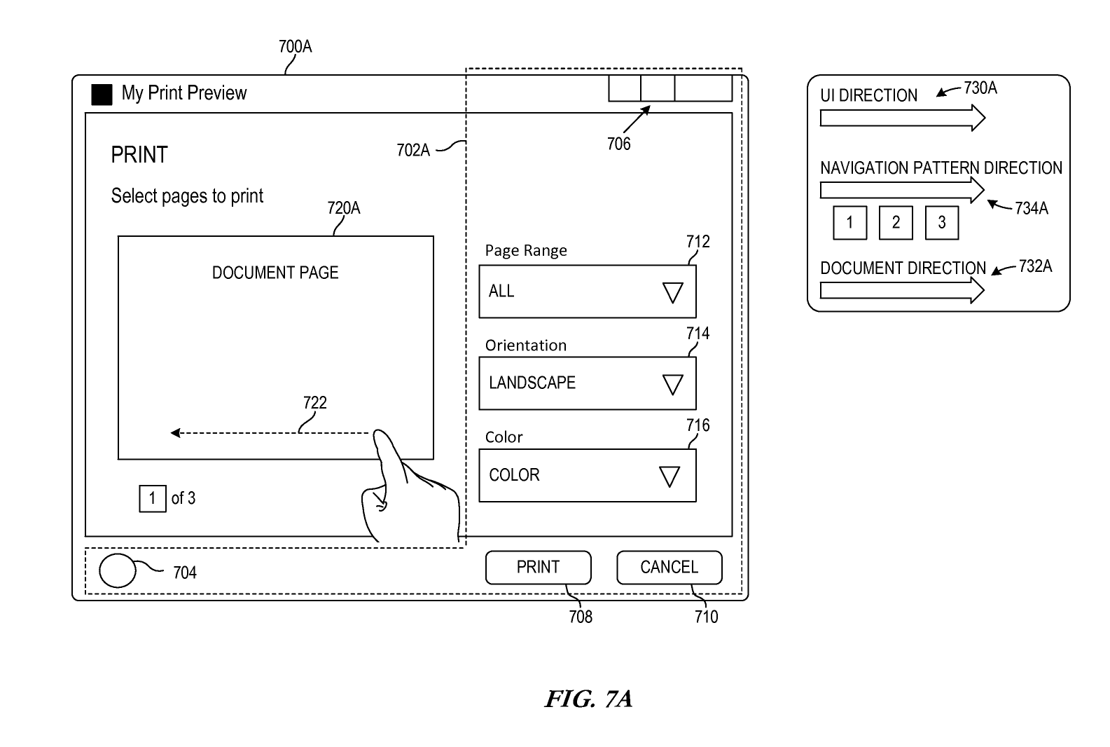

FIGS. 5A-5D depict a representative manner of establishing content navigational direction, and subsequent navigation within the content once navigational direction is established. In FIGS. 5A-5D, like reference numbers are used to identify like items. Referring first to FIG. 5A, a first page of a document or other content item is depicted as document page-1 300A. Regardless of the UI orientation, or even the document orientation, the user can make a UI gesture to indicate the content navigation direction. In the illustrated embodiment, the UI mechanism is assumed to be a touch screen, where the user can move his/her finger in a direction that would advance to the next page of the document.

In one embodiment, the first such touch gesture establishes the navigational direction for that instance of the document. In FIG. 5A, the first touch gesture is a right-to-left touch gesture 302 that establishes the navigational pattern for that document. When the touch gesture 302 (e.g. drag, swipe, etc.) is made, the document also advances to the next page of the document, shown in FIG. 5B as document page-2 300B. Another touch gesture 302 in the same direction advances or turns the page, resulting in document page-3 300C of FIG. 5C. As the document “advancement” direction has been established according to a LTR document (due to right-to-left page turning or animation), a touch gesture in the opposite direction will cause the document to return to the previous page. This is depicted at FIG. 5C, where a left-to-right touch gesture 304 is made, which returns to a previous page when such gesture is in a direction predominantly opposite to the established navigation direction. The resulting document page is shown at FIG. 5D, where the document is shown to have returned to document page-2 300B.

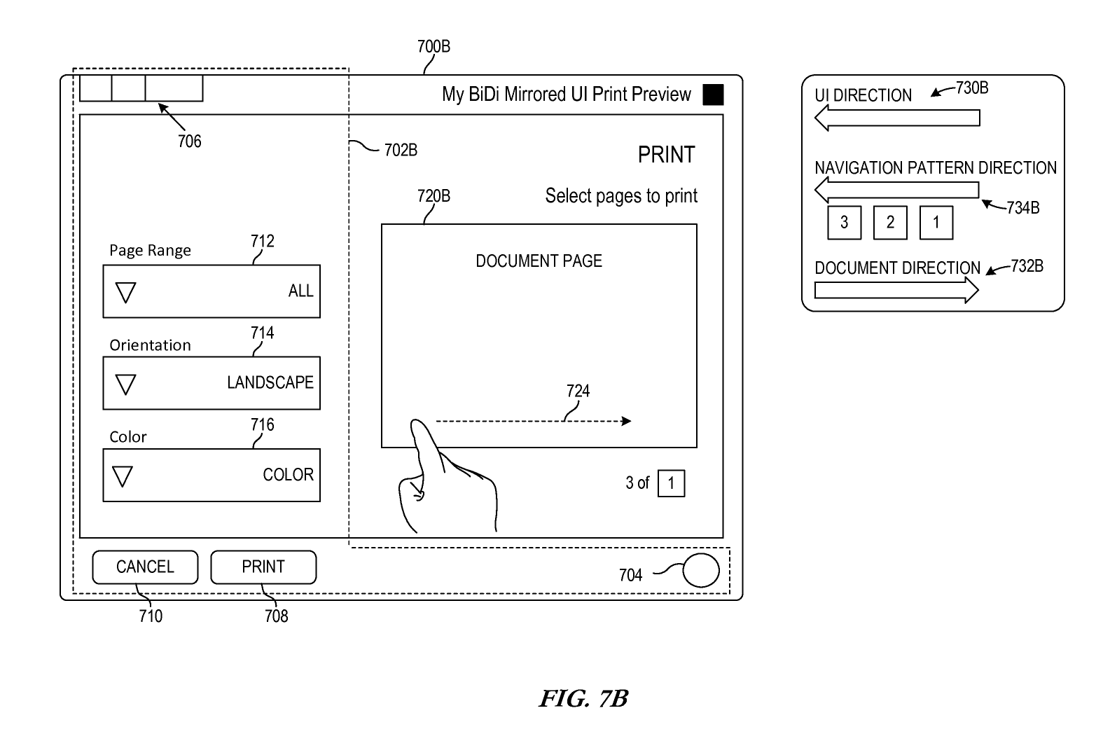

The arrangement of pages or other content pieces is further illustrated in connection with FIG. 6. Touch gesture-based navigation pattern direction as described herein allows pattern-based navigation controls to no longer be bound to the directional orientation of the UI, by leveraging the user's touch gesture direction in order to identify the desired navigation pattern direction. As noted above, previous implementations of navigation-type controls inherit or set the horizontal pattern orientation based on the UI orientation/direction. Binding navigational control layout orientation to UI language directional orientation may introduce limitations in the user experience. Under certain conditions, the UI and navigation control pattern layout direction may be opposite to that of the content direction.

For purposes of example, FIG. 6 is described in terms of a document presented on a computing device, where the UI gesture is made by way of a touch screen or other touch-based mechanism. As depicted in FIG. 6, the first page 602 of the initial default state 600 of the multi-page document is presented in the navigation sequence. The second page in the navigation sequence may be included in this initial default state 600, but may not be displayed. This is depicted by the second pages 604A and 604B, which represent possible control states for the second page depending on the gesture input by the user. If the user gestures to mimic a page turn from left to right, indicating a RTL navigational direction, the control state 610 is utilized. In this case, the next page is 604A, followed by page 606, etc. This RTL orientation is established based on the RTL navigational gesture, which then allows moving forward or backwards in the document based on the direction of the gesture relative to the initial gesture that established the navigational direction. Alternatively, if the user gestures to mimic a page turn from right to left, indicating a LTR navigational direction, the control state 620 is utilized. In this case, the next page is 604B, followed by page 606, etc. The control state returns to control state 600 once reinitiated, such as when a new document or other content is loaded into the display or other presentation area of the user device.

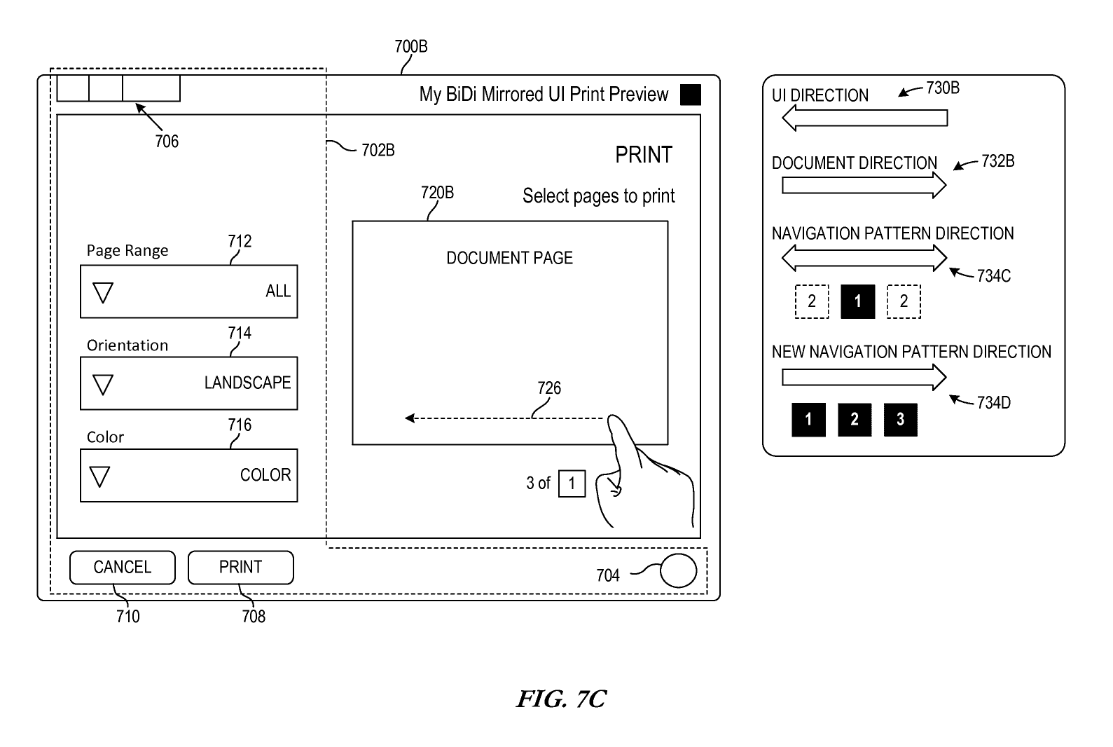

A representative example shown in the context of a user device is described in FIGS. 7A-7C. In FIGS. 7A-7C, like reference numbers are used to identify like items, and similar items may be represented by like reference numbers but different trailing letters. In this example, a graphical user interface (GUI) screen 700A is presented on a display, such as a touch-based display or touchscreen. A UI orientation, depicted by representative UI functions 702A, may be oriented based on the language of the operating system. For example, in the embodiment of FIG. 7A, the user interface is configured for LTR languages. This is depicted by the left-to-right arrow of the UI direction 730A. The representative UI functions 702A may include, for example, menu items 704, control items 706 (e.g. minimize, maximize, etc.), commands 708, 710, etc. In the illustrated embodiment, the representative GUI screen 700A represents a print preview screen, invoking UI functions such as the print page range 712, paper orientation 714, print color 716, etc.

The GUI screen 700A also presents content, which in the print preview example of FIG. 7 includes an initial document page 720A of a plurality of print images associated with the content being printed. In this example, if the user would like to review the pages to be printed, the user can scroll or otherwise advance through the document. As previously described, one embodiment involves recognizing the user's first gesture indicative of a scrolling direction, and setting the navigational direction based on that first gesture. For example, in the example of FIG. 7A, the user has moved his/her finger towards the left from a position on the image or document page 720A, as indicated by arrow 722. This indicates an attempt to “turn the page” in a document or other content arranged left-to-right, thereby indicating a LTR navigational direction. In this example the document may be an English document written in a LTR fashion, as noted by the document direction 732A. While within the user's discretion, with an LTR-oriented document and LTR-oriented UI functions 702A, the user may very well intuitively advance pages of the multi-page document/image in a left-to-right fashion. If so, this will establish a navigational pattern direction 734A in a left-to-right fashion, such that further user gestures in the same direction will advance the document pages forward, while user gestures in a generally opposite direction will move back in the document pages. The example of FIG. 7A represents matching patterns, where the UI direction 730A is configured in the same orientation as the document direction 732A, where navigation would likely advance in the same direction.

FIG. 7B represents a non-matching pattern, where the UI direction 730B is configured in a different orientation as the document direction 732B. In this example, the GUI screen 700B includes UI functions 702B in a RTL orientation, such as might be the case where the operating system is a Hebrew or Arabic operating system. The document direction 732B is arranged left-to-right, such as an English document. The example of FIG. 7B therefore provides an example of viewing, or in this case previewing for printing, an English or other LTR-oriented document of which a document page 720B is depicted. With a RTL UI direction 730B, the user may try to advance the LTR document by gesturing in a left-to-right fashion (e.g. turning pages RTL) as depicted by arrow 724. In prior systems, the user could in fact be moving backwards in a document, rather than moving forward as was desired, due to this mismatch.

FIG. 7C represents how techniques in accordance with the present disclosure provide solutions to such potential non-matching patterns. This example initially assumes the same circumstances as described in connection with FIG. 7B, in that the UI functions 702B are in a RTL orientation as shown by the UI direction 730B, and the document direction 732B is arranged in an LTR orientation. However, in this example, there is not yet any established navigational pattern direction 734C, as depicted by the multi-directional arrow. The first document page 720B is presented, but the navigational pattern direction 734C will not be established until the user gestures to set the direction. In the example of FIG. 7C, the user moves his/her finger generally in a leftward motion as depicted by arrow 726. This suggests turning pages or otherwise advancing through the document from left to right. Based on this gesture, a new navigation pattern direction 734D is established. Further user gestures toward the left will advance the document pages 720B forward, while gestures toward the right will return the document to a previous page.

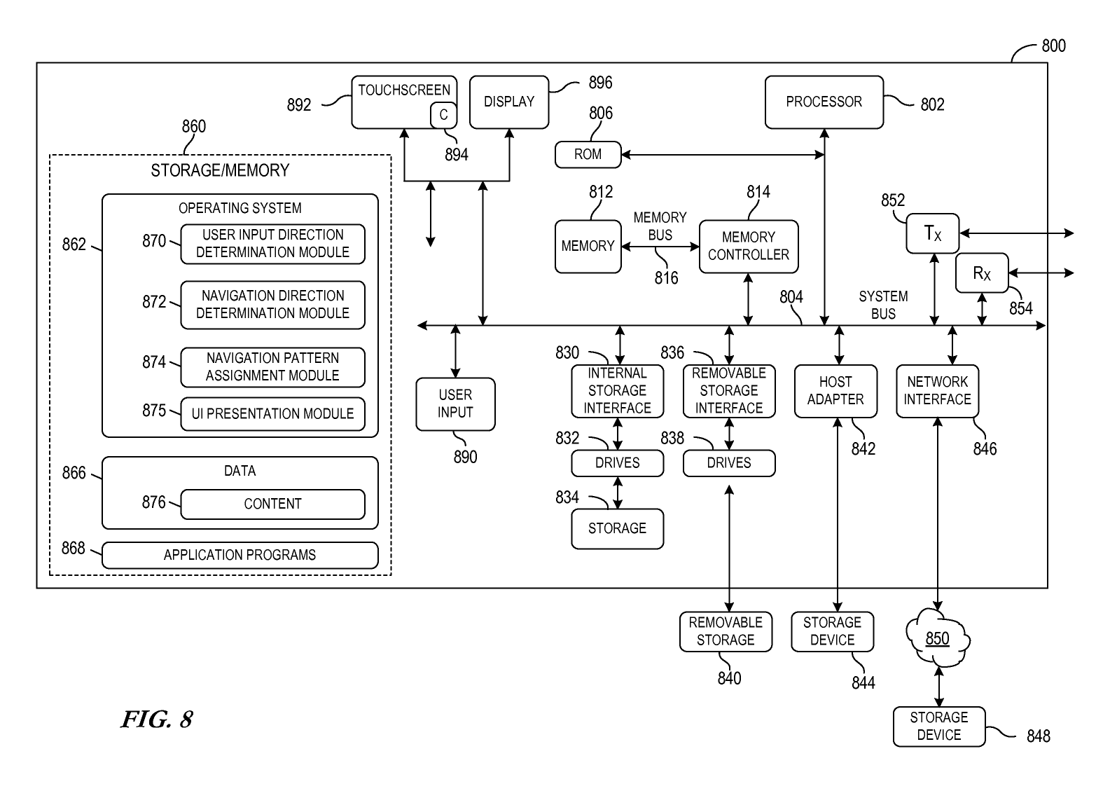

FIG. 8 depicts a representative computing apparatus or device 800 in which the principles described herein may be implemented. The representative computing device 800 can represent any computing device in which content can be presented. For example, the computing device 800 may represent a desktop computing device, laptop or other portable computing device, smart phone or other hand-held device, electronic reading device (e.g. e-book reader), personal digital assistant, etc. The computing environment described in connection with FIG. 8 is described for purposes of example, as the structural and operational disclosure for facilitating dynamic gesture-based navigational direction establishment is applicable in any environment in which content can be presented and user gestures may be received. It should also be noted that the computing arrangement of FIG. 8 may, in some embodiments, be distributed across multiple devices (e.g. system processor and display or touchscreen controller, etc.).

The representative computing device 800 may include a processor 802 coupled to numerous modules via a system bus 804. The depicted system bus 804 represents any type of bus structure(s) that may be directly or indirectly coupled to the various components and modules of the computing environment. A read only memory (ROM) 806 may be provided to store firmware used by the processor 802. The ROM 806 represents any type of read-only memory, such as programmable ROM (PROM), erasable PROM (EPROM), or the like.

The host or system bus 804 may be coupled to a memory controller 814, which in turn is coupled to the memory 812 via a memory bus 816. The navigation direction establishment embodiments described herein may involve software that stored in any storage, including volatile storage such as memory 812, as well as non-volatile storage devices. FIG. 8 illustrates various other representative storage devices in which applications, modules, data and other information may be temporarily or permanently stored. For example, the system bus 804 may be coupled to an internal storage interface 830, which can be coupled to a drive(s) 832 such as a hard drive. Storage 834 is associated with or otherwise operable with the drives. Examples of such storage include hard disks and other magnetic or optical media, flash memory and other solid-state devices, etc. The internal storage interface 830 may utilize any type of volatile or non-volatile storage.

Similarly, an interface 836 for removable media may also be coupled to the bus 804. Drives 838 may be coupled to the removable storage interface 836 to accept and act on removable storage 840 such as, for example, floppy disks, compact-disk read-only memories (CD-ROMs), digital versatile discs (DVDs) and other optical disks or storage, subscriber identity modules (SIMs), wireless identification modules (WIMs), memory cards, flash memory, external hard disks, etc. In some cases, a host adaptor 842 may be provided to access external storage 844. For example, the host adaptor 842 may interface with external storage devices via small computer system interface (SCSI), Fibre Channel, serial advanced technology attachment (SATA) or eSATA, and/or other analogous interfaces capable of connecting to external storage 844. By way of a network interface 846, still other remote storage may be accessible to the computing device 800. For example, wired and wireless transceivers associated with the network interface 846 enable communications with storage devices 848 through one or more networks 850. Storage devices 848 may represent discrete storage devices, or storage associated with another computing system, server, etc. Communications with remote storage devices and systems may be accomplished via wired local area networks (LANs), wireless LANs, and/or larger networks including global area networks (GANs) such as the Internet.

The computing device 800 may transmit and/or receive information from external sources, such as to obtain documents and other content for presentation, code or updates for operating system languages, etc. Communications between the device 800 and other devices can be effected by direct wiring, peer-to-peer networks, local infrastructure-based networks (e.g., wired and/or wireless local area networks), off-site networks such as metropolitan area networks and other wide area networks, global area networks, etc. A transmitter 852 and receiver 854 are shown in FIG. 8 to depict a representative computing device's structural ability to transmit and/or receive data in any of these or other communication methodologies. The transmitter 852 and/or receiver 854 devices may be stand-alone components, may be integrated as a transceiver(s), may be integrated into or already-existing part of other communication devices such as the network interface 846, etc.

The memory 812 and/or storage 834, 840, 844, 848 may be used to store programs and data used in connection with the various techniques for dynamically establishing content navigation directions from user input indicative of an initial navigational direction. The storage/memory 860 represents what may be stored in memory 812, storage 834, 840, 844, 848, and/or other data retention devices. In one embodiment, the representative device's storage/memory 860 includes an operating system 862, which may include the code/instructions for presenting the device GUI. For example, a UI presentation module 875 may be provided to be responsible for the presentation of the UI, such as the GUI that may be oriented according to language.

Associated with the operating system 862, or separate therefrom, software modules may be provided for performing functions associated with the description herein. For example, a user input direction determination module 870 may be provided, which in one embodiment involves processor-executable instructions to determine the direction gestured by the user on a touchscreen 892 or via other user input 890. In one embodiment, a navigation direction determination module 872 determines the content pattern direction in view of the directional information determined via the user input direction determination module 870. For example, if the user input direction is determined to be from right to left, the navigation direction determination module 872 may ascertain that such a gesture corresponds to a LTR navigational content pattern direction. Further, a navigation pattern establishment/assignment module 874 may be provided to establish the content navigation direction to correspond to the navigation direction determined from the user's initial gesture. Any one or more of these modules may be implemented separately from the operating system 862, or integrally with the operating system as depicted in the example of FIG. 8.

The device storage/memory 860 may also include data 866, and other programs or applications 868. Any modules 870, 872, 874 may be alternatively provide via programs or applications 868 rather than via an operating system. While documents and other content that is presented to the user may be provided in real-time via the Internet or other external source, the content 876 may be stored in memory 812 temporarily and/or in any of the storage 834, 840, 844, 848, etc. The content 876 may represent multi-page or multi-segment content that is presented in multiple portions, such as pages 1-20 of a document, whether the portions are associated with the original document or reformatted at the computing device 800. These modules and data are depicted for purposes of illustration, and do not represent an exhaustive list. Any programs or data described or utilized in connection with the description provided herein may be associated with the storage/memory 860.

The computing device 800 includes at least one user input 890 or touch-based device to at least provide the user gesture that establishes the content navigation direction. A particular example of a user input 890 mechanism is separately shown as a touchscreen 892, which may utilize the processor 802 and/or include its own processor or controller C 894. The computing device 800 includes at least one visual mechanism to present the documents or content, such as the display 896.

As previously noted, the representative computing device 800 in FIG. 8 is provided for purposes of example, as any computing device having processing capabilities can carry out the functions described herein using the teachings described herein.

As demonstrated in the foregoing examples, the embodiments described herein facilitate establishing a navigation pattern direction based on a user's directional input or “gestures.” In various embodiments, methods are described that can be executed on a computing device(s), such as by providing software modules that are executable via a processor (which includes one or more physical processors and/or logical processors, controllers, etc.). The methods may also be stored on computer-readable media that can be accessed and read by the processor and/or circuitry that prepares the information for processing via the processor. For example, the computer-readable media may include any digital storage technology, including memory 812, storage 834, 840, 844, 848 and/or any other volatile or non-volatile storage, etc.

Any resulting program(s) implementing features described herein may include computer-readable program code embodied within one or more computer-usable media, thereby resulting in computer-readable media enabling storage of executable functions described herein to be performed. As such, terms such as “computer-readable medium,” “computer program product,” computer-readable storage, computer-readable media or analogous terminology as used herein are intended to encompass a computer program(s) existent temporarily or permanently on any computer-usable medium.

Having instructions stored on computer-readable media as described herein is distinguishable from instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A computer-implemented method comprising:
receiving user input indicative of a direction for advancing presented content arranged by sequence; and
establishing a navigation direction for the presented content to correspond to the direction indicated by the user input.

2. The computer-implemented method of claim 1, wherein receiving user input indicative of a direction for advancing presented content comprises receiving the direction for advancing the presented content from a first directional touch gesture involving the presented content via a touch-based input.

3. The computer-implemented method of claim 2, wherein receiving the direction for advancing the presented content from a first directional touch gesture comprises receiving the direction from a simulated page turning motion applied to the presented content via a touchscreen.

4. The computer-implemented method of claim 2, further comprising resetting the navigational direction for newly presented content, and wherein:
receiving user input comprises receiving new user input indicative of a direction for advancing the newly presented content; and
establishing a navigation direction comprises establishing a navigation direction for the newly presented content to correspond to the direction indicated by the new user input.

5. The computer-implemented method of claim 1, wherein receiving user input comprises receiving an initial user input indicative of the direction for advancing the presented content, and further comprising advancing the presented content in its arranged sequence in response to further user input imparting the same direction.

6. The computer-implemented method of claim 1, wherein receiving user input comprises receiving an initial user input indicative of the direction for advancing the presented content, and further comprising moving backwards in the arranged sequence of the presented content in response to user input imparting a direction different than the direction of the initial user input that established the navigation direction.

7. The computer-implemented method of claim 6, wherein the direction different than the direction of the initial user input comprises a direction that is generally opposite to the direction of the initial user input.

8. The computer-implemented method of claim 1, further comprising a graphical user interface having an orientation dependent on an operating system language, and wherein establishing a navigation direction for the presented content comprises establishing the navigation direction for the presented content to correspond to the direction indicated by the user input regardless of whether the operating system language is a left-to-right, right-to-left, or bi-directional language.

9. The computer-implemented method of claim 1, wherein establishing a navigation direction for the presented content comprises establishing a horizontal navigation direction for the presented content.

10. The computer-implemented method of claim 1, wherein establishing a navigation direction for the presented content comprises establishing a vertical navigation direction for the presented content.

11. An apparatus comprising:
a touch-based user input configured to receive an initial user-initiated gesture conveying a direction of a first attempt to navigationally advance a multi-part content item;
a processor configured to recognize the conveyed direction of the user-initiated gesture, determine a content navigation direction based on the conveyed direction, and establish the content navigation direction as the navigation direction of the multi-part content item; and
a display for presenting a current part of the multi-part content item.

12. The apparatus as in claim 11, wherein the processor is further configured to advance forward in the multi-part content item in response to further user-initiated gestures in the same direction as the initial user-initiated gesture.

13. The apparatus as in claim 11, wherein the processor is further configured to move backward in the multi-part content item in response to further user-initiated gestures in a direction generally opposite to the initial user-initiated gesture.

14. The apparatus as in claim 11, further comprising storage configured to store an operating system, wherein the processor is configured to execute instructions associated with the operating system to at least recognize the conveyed direction of the user-initiated gesture, determine the content navigation direction, and establish the content navigation direction as the navigation direction of the multi-part content item.

15. The apparatus as in claim 11, wherein the display comprises a touchscreen, and wherein the touch-based user input is implemented integrally to the touchscreen.

16. Computer-readable media having instructions stored thereon which are executable by a processor for performing functions comprising:
providing a user interface having an orientation corresponding to a language of an operating system executable by the processor;
presenting multi-page content having an orientation different from the orientation of the user interface;
identifying an initial touch gesture indicative of a direction for navigating forward in the multi-page content;
establishing a navigation direction for the multi-page content based on the direction indicated by the initial touch gesture;
moving forward in the multi-page content in response to subsequent touch gestures in the same direction as the initial touch gesture; and
moving backward in the multi-page content in response to subsequent touch gestures in a direction different from the initial touch gesture.

17. The computer-readable media as in claim 16, wherein:
the instructions for providing a user interface comprise instructions for providing a user interface having one of a left-to-right user interface orientation corresponding to a first group of the languages of the operating system, and a right-to-left user interface orientation corresponding to a second group of the languages of the operating system; and
the instructions for presenting multi-page content having an orientation different from the orientation of the user interface comprise instructions for presenting the multi-page content having a left-to-right orientation for the right-to-left user interface orientation, or presenting the multi-page content having a right-to-left orientation for the left-to right user interface orientation.

18. The computer-readable media as in claim 16, wherein the instructions for moving backward in the multi-page content comprise instructions for moving backward in the multi-page content in response to subsequent touch gestures in a direction generally opposite to the initial touch gesture.

19. The computer-readable media as in claim 16, wherein the instructions for identifying an initial touch gesture comprise instructions for identifying a directional swipe across a touchscreen, where the directional swipe causes advancement to a next page of the multi-page content and accordingly indicates the direction for navigating forward in the multi-page content.
